(19) United States
(12) Patent Application Publication
(10) Pub. No.: US 2006/0254592 A1
(43) Pub. Date: Nov. 16, 2006

(54) Respiratory mask

(76) Inventors: Bruce Anders, Anchorage, AK (US); Irving Anders, Fitchburg, WI (US)

Correspondence Address: FOLEY & LARDNER LLP, 150 EAST GILMAN STREET, P.O. BOX 1497, MADISON, WI, 53701-1497, US

(21) Appl. No.: 11/046,072

(22) Filed: Jan. 28, 2005

(51) Int. Cl. A62B 18/02; A62B 23/02; A62B 18/08

(52) U.S. Cl. 128/206.21; 128/207.13; 128/205.25; 128/206.26; 128/206.12; 128/206.18; 128/206.28; 128/207.12

(57) ABSTRACT

A half-face respiratory mask is disclosed. The respiratory mask has replaceable filters associated with inhalation valves, the filters further having a minimal relief from an outer surface of the respiratory mask. The respiratory mask may be made of a substantially transparent material, a substantially colorless material, or both, or of a aesthetically pleasing color scheme, and may be of a size, weight, and design such that the respiratory mask is physically discreet and unobtrusive to the user for everyday or active use, and is unobtrusive, discreet, or otherwise aesthetically appealing to users and passersby.

### FIELD OF INVENTION

This invention relates to half-face respiratory masks, especially those respiratory masks that are aesthetically pleasing, discreet, and unobtrusive for the user and passersby and are intended to protect the wearer from biological, chemical, and foreign object inhalants.

### BACKGROUND OF THE INVENTION

In the world today, many people are concerned for their own personal safety. Exposure to airborne pollutants has been linked to a variety of respiratory and cardiac health effects. Airborne particulate matter, known as PM, is one of the major components of smog. PM also includes microscopic particles in the air. These particles, capable of being inhaled by humans, are divided into two size ranges: “fine” and “coarse” particulate matter.

“Fine” particles less than 2.5 micrometers in size (PM2.5) are responsible for causing the greatest harm to human health. 1/20th the width of a human hair, these fine particles can be inhaled deep into the lungs reaching areas where the cells replenish the blood with oxygen. They can cause breathing and respiratory ailments including irritation, inflammation and damage to the lungs and premature deaths.

Some PM2.5 is released directly to the atmosphere from industrial smokestacks and automobile tailpipes, but a large percentage is actually formed in the atmosphere from other pollutants such as sulphur dioxide (SO₂), nitrogen oxides (NOₓ) and volatile organic compounds (VOCs). Major sources of these other pollutants may include fossil fuel combustion in motor vehicles, power plant and industrial emissions, as well as industrial processing and solvent vapors.

Although not as serious a threat to human health as PM2.5, “coarse” particles covering the range from 2.5 to 10 micrometers in diameter (PM<10), are also known to cause adverse health effects. When inhaled, they tend to be deposited in the upper parts of the respiratory system from which they can be eventually expelled back into the throat. Coarse particles generally remain in the form in which they are released into the atmosphere without chemical transformation, eventually settling out under the influence of gravity. While some of these coarse particles are generated naturally from sea salt spray, wind and wave erosion, volcanic dust, windblown soil, and pollen, they are also produced by human activities, such as construction, demolition, mining, road dust, tire wear, and grinding processes of soil, rocks, or metals.

Obviously, critical and acute airborne particulates present a dangerous, immediate threat. In addition to the above mentioned airborne particulate matter, other airborne health hazards include threatened and horrifying realities such as outbreaks of severe acute respiratory syndrome (SARS), other inhalant viruses, and chemical or biological weapons attacks.

Typical respiratory masks protect users against such inhalants and are available in a variety of configurations, such as fiber filters and larger, air-purifying chemical respirators. While these masks are effective in purifying air that the user inhales, they tend to be large, heavy, opaque, unsightly, or otherwise obtrusive to the user.

Fiber filters, commonly known as surgical masks, are readily available but are not aesthetically pleasing due to their opacity. More importantly, most surgical masks fail to achieve an effective hermetic seal around the face, drastically decreasing their effectiveness. “Industrial” quality air purifying respiratory masks that utilize replaceable, long-life filtration cartridges are also available, and are effective in protecting against vapors and gases. However, industrial respirator masks tend to be bulky, made of opaque or otherwise visually obtrusive rubber and plastics, and prominently protrude from both sides of the user's face.

While fiber filter masks fail to achieve optimum filtration due to their loose seal, and air-purifying respiratory masks provide an adequate seal but are visually and physically obtrusive, average persons desiring a personal respirator outside of industrial manufacturing or research facilities seek a filtration mask that is easily transported such as in a purse or briefcase; is light-weight and sleek for everyday wear during outdoor, athletic or other activities where airborne pollution and contaminants are of a concern; and is aesthetically stylish or sporty, or at least is as unnoticeable as possible.

The present invention provides a respiratory mask that provides respiratory protection against various airborne pollutants, is aesthetically discreet, is physically unobtrusive through its light weight and sleek shape, is easily stored, and does not require extensive training in proper usage.

### SUMMARY OF THE INVENTION

New respiratory masks that provide protection against various airborne pollutants are provided. The respiratory masks of the present invention are intended to be aesthetically and physically discreet and unobtrusive, and less bulky than previously reported half-face respiratory masks.

In one embodiment, the respiratory mask is of a half-face style, or in other words the respiratory mask covers the lower portion of a user's face including the nose and mouth, while at the same time not covering the eyes and upper cheek areas of a user. The respiratory mask may be minimally-sized to fit the face of the wearer, and not protrude significantly from the sides of the face. The respiratory mask may be composed of light-weight materials. In this embodiment, the respiratory mask may be worn for extended periods of time or during strenuous physical activity, such as jogging, without the wearer experiencing discomfort or instability from a weighty or bulky mask.

In another embodiment, the respiratory mask includes at least one one-way exhalation valve and at least one one-way inhalation valve, with the at least one one-way inhalation valve having an associated filter to protect the wearer of the respiratory mask from different types of inhalants, and with the filter having a minimal relief from the outer surface of the respiratory mask.

As used in the present invention, relief is defined as how far an item is raised relative to other areas in close proximity. For example, when referring to the respiratory mask, relief is the term given to how far the respiratory mask sticks out from the face of the user, and when referring to the filters, relief is the term given to how far the filter sticks out from the outer surface of the respiratory mask, with the outer surface being the surface of the respiratory mask that faces away from the user. Therefore, minimal relief is the term given to that relief that is the least amount of relief possible, without compromising the integrity of the filter or the respiratory mask. The minimal relief of a filter may be as little as a flush fit to the outer surface of the respiratory mask so that no discernable difference in the profile of the respiratory mask and filter are apparent, or the minimal relief of a filter may be a noticeable difference between the profile of the outer surface of the respiratory mask and the profile of the filter.

In another embodiment, the inhalation valve or valves are mounted on a portion of the respiratory mask at a location that extends from the chin and laterally up the respiratory mask over the wearer's jaw-line toward the earlobe.

In another embodiment, the one-way inhalation valve may be elongated and extend in a smile-like shape or crescent shape from the region of the mask nearest an earlobe of the user, through the chin region of the mask, and back to a region of the mask nearest the other earlobe of the user. The valve may also extend along the jaw-line of the user in such an embodiment. The one-way inhalation valve may also be a series of two or more valves extending through a similar region of the mask.

In another embodiment, the elongated valves may extend in either one or both directions from the chin region of the mask up the jaw-line region of the mask, but not fully to the earlobe region of the mask.

In another embodiment, the exhalation valve or valves may be incorporated into the area of the respiratory mask covering the wearer's mouth, and the shape of the exhalation valve may be other than circular.

In another embodiment, the respiratory mask of the present invention may be made of materials that are substantially transparent, substantially colorless, or both, or in whole or in part use a color scheme of multiple colors that is stylish or otherwise visually appealing.

As used in reference to the present invention, substantially transparent is defined as the view through a particular material being unobstructed by hazing, bubbling, fillers, or other opaque additives. However, it is contemplated that a substantially transparent material may be subject to image distortion or imperfections in the particular material used to construct the respiratory mask and associated parts described herein. Substantially colorless is defined as the particular material not having a noticeable coloration, however it is contemplated that some inherent coloration in the material due to diffraction, thickness variations, or material imperfections, may be apparent.

In another embodiment, the filter may be a fiber filter, or a filter containing purification agents such as activated carbon, such filters being known to those of ordinary skill in the art, and the filter may be capable of filtering out one or more inhalants such as biological agents, chemical agents, and foreign objects. Biological agents may include those agents such as viruses, bacteria, and other pathogens. Chemical agents may include those agents such as gases, mists, vapors, aerosols, and liquids. Foreign objects may include those objects such as particulate matter, dust, smoke, hair, insects, dander, and pollen.

In another embodiment, the filter or filters of a respiratory mask may be integrally incorporated into the respiratory mask, such that the filter or filters have minimal relief from the surrounding outer surface of the respiratory mask. The integral incorporation may be achieved by several modes of attachment such as the filter body twisting into a receiver part of the respiratory mask, in a snap-in-snap-out configuration, or other appropriate connection arrangement that is known to those of ordinary skill in the art. The receiver part of the respiratory mask may be associated with the inhalation valve or valves. The filter or filters may also be removable to allow for interchange between new and spent filters or interchange between filters that filter different inhalants under changing conditions.

In another embodiment, the respiratory mask may further comprise a rolled edge on the mask portion. The rolled edge is an inwardly turned, fully incorporated portion of the respiratory mask. The rolled edge is intended to provide a comfortable fit of the respiratory mask on the user's face by using a rounded edge to contact and conform to the irregular shape of the face, to provide for a better seal with the face of the user to prevent leakage, and to allow for the mask to be worn by users having diverse and variant facial shapes and sizes.

In another embodiment, a single inhalation valve may be incorporated into the area of the respiratory mask covering the wearer's chin, and the shape of the inhalation valve may be other than circular.

In another embodiment, when more than one inhalation valve is incorporated in the respiratory mask, the inhalation valves may be located in the mask portions covering opposite sides of the wearer's chin. When one or more valves are incorporated in the chin portion of the respiratory mask, one or more of the valves may be circular. The inhalation valves may be located in a series along the chin portion and covered by either a single filter that is of an appropriate shape and size to encompass all the inhalation valves, or multiple filters. The series of inhalation valves along the chin portion may extend along the portion of the respiratory mask, that covers the jaw-line of the wearer, toward the portion of the respiratory mask closest to the ear or earlobe of the wearer.

The size, shape and location of the inhalation and exhalation valve or valves may vary depending upon the location at which the valves are incorporated into the respiratory mask, the size of the respiratory mask, the overall aesthetic appeal of the respiratory mask, or at the discretion of the designer of the respiratory mask.

### BRIEF DESCRIPTION OF THE DRAWINGS

FIG. 1 is a frontal view of a first embodiment of a respiratory mask.

FIG. 2 is a detail view of a valve for use in a respiratory mask.

FIG. 3 is a view of a second embodiment of a respiratory mask with chin inhalation valves.

FIG. 4 is a view of a third embodiment of a respiratory mask with elongated chin inhalation valves.

FIG. 5 is a side view of a first embodiment of a respiratory mask.

FIG. 6 is a side view of a second embodiment of a respiratory mask.

### DETAILED DESCRIPTION OF THE INVENTION

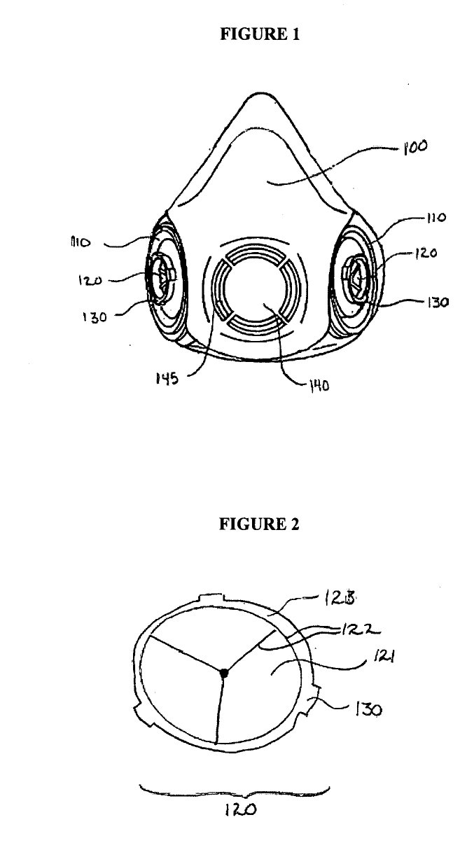

The respiratory mask 100 of the present invention is represented in FIGS. 1-5. The respiratory mask 100 may be constructed of a suitable, flexible, substantially transparent material such as polyvinyl chloride, polyethylene, polypropylene, silicone rubbers, or other moldable materials that are non-allergenic or non-sensitizing and are suitable for the invention described. The respiratory mask 100 may also be substantially colorless in addition to being substantially transparent, or may utilize multiple colors in stylish or appealing patterns or schemes.

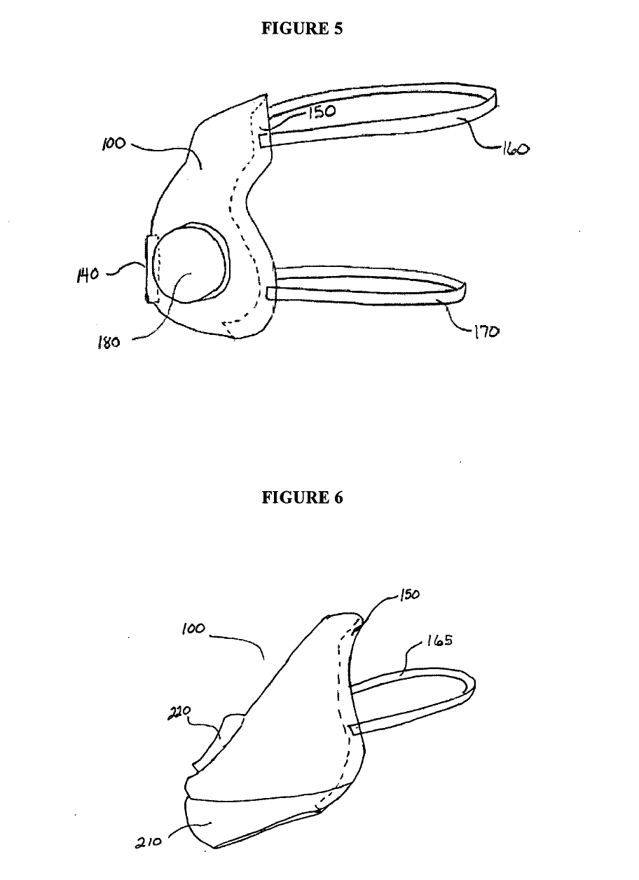

Incorporated into the respiratory mask are one-way inhalation 120 and one-way exhalation 140 valves. The relative positions of the inhalation valves may be reversed from the positions depicted in FIGS. 1 and 5. All valves may be constructed in a similar manner. Each valve may include a port 123 incorporated into the body of the respiratory mask 100 with a flexible valve flap 121 that contacts a valve seat 122, and a way of attaching a filter cartridge such as by a bayonet-style coupling 130, threading, snap-fitting, or other suitable connections known to those of ordinary skill in the art. The inhalation and exhalation valves may be circular, ovular, or otherwise elongated, such as an elongated oval or crescent shape extending laterally up the respiratory mask over the wearer's jaw-line toward the earlobe, to conform with the goal of minimizing their relief and maximizing the respiratory mask's sleek design.

The flexible valve flap 121 may be circular, or otherwise elongated to conform to the shape of the valve, and connected to the rest of the valve by a pin through the center of the flexible valve flap 121 as shown in FIG. 2, the flexible valve flap 121 may be U-shaped such that the top of the U is secured while the rest of the U forms a seal with the valve seat 122, or the flexible valve flap and the manner of securing the valve flap may be of any other appropriate arrangement that is known to those of ordinary skill in the art. As shown in FIG. 2, the flexible valve flap 121 may be supported by a spoke arrangement, a grid arrangement, or by any other suitable arrangement, many of which are known to those of ordinary skill in the art. The valve flap(s) 121 on the exhalation valve(s) 140 are seated during inhalation by the user. Conversely, the valve flap(s) 121 on the inhalation valve(s) 120 are seated during exhalation by the user.

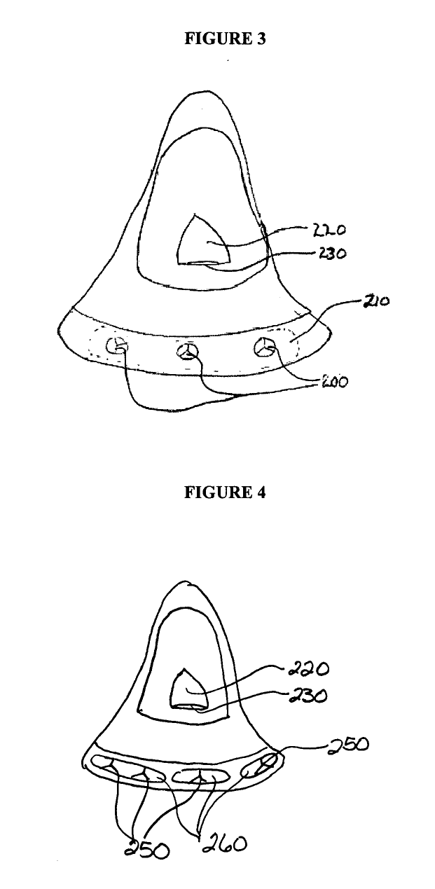

The inhalation 120 and exhalation 140 valves may be located in several portions of the respiratory mask 100. The exhalation valve(s) 140 may be located in a portion of the respiratory mask 100 near the user's mouth to reduce respiratory condensation as depicted in FIGS. 1, 3, and 4, or the exhalation valve(s) 140 may also be located in any portion of the respiratory mask. The exhalation valve(s) 140 may be disguised by a vented cover 145 as depicted in FIG. 1, or by a directional valve cover 220 and vent 230 as depicted in FIG. 3.

The inhalation valve 120 may be one of several such valves incorporated into the respiratory mask. The inhalation valve 120 may be located in several positions, such as in a lateral position with respect to the exhalation valve 140, in a substantially equidistant arrangement of two inhalation valves 120 around the exhalation valve 140, as shown in FIG. 1, as a single valve in either position, as chin inhalation valves 200 located in the chin region of the respiratory mask 100, as depicted in FIG. 3, or as an elongated oval or crescent shaped valve or valves 260 extending from the region covering the user's chin, along the portion of the respiratory mask covering the user's jaw-line toward the wearer's earlobe, as shown in FIG. 4. A lateral position is defined as being in a position generally horizontal with respect to the exhalation valve, when the respiratory mask is in place on the face of a user. A substantially equidistant arrangement is defined as a generally symmetrical arrangement of the inhalation valves 120 about the exhalation valve(s) 140. It is not an object of the present invention that the lateral position be perfectly horizontal, nor the substantially equidistant arrangement be perfectly spaced or perfectly symmetrical. The size and shape of the inhalation 120 and exhalation 140 valves can vary depending upon the overall size of the respiratory mask, user preferences, aesthetic considerations, and other factors. For example, the shape may be circular, oblong, ovular, crescent-shaped, or multi-sided. Multi-sided is defined as any shape other than round or oval and includes square, rectangular, triangular, pentagonal, hexagonal, heptagonal, octagonal, or any other shape that will allow the valve to function in its intended manner, and also includes those same shapes with regular, defined corners or rounded corners. In keeping with the inconspicuous and unobtrusive nature of the invention, the respiratory mask and all valves and valve materials may be constructed of materials that are in whole or in part substantially transparent, substantially colorless, or both, or use in whole or in part a color scheme that is stylish or otherwise visually appealing.

The inhalation valve(s) 120 may be covered by a filter cartridge 180 that locks into place over the valve. The filter cartridge 180 may attach by one of several modes such as threading, pressure-fit snapping, bayonet-style couplings, or other connections known to those of ordinary skill in the art. The filter cartridge 180 forms an airtight seal with the receiver 110 of the respiratory mask so that no inhalants are able to leak around the filter cartridge and into the respiratory system of the user. The connection site for the filter to the respiratory mask body may be located near the valve as depicted by the coupling 130 in FIGS. 1 and 2, or the connection site may be built into the receiver as threads, snap-in-snap-out couplings, or other connections known to those of ordinary skill in the art.

The filter cartridge(s) 180 may be as minimally sized as possible so that their physical bulk is unobtrusive, discreet, and aesthetically pleasing. The filter cartridges may have some relief from the natural curvature or surface of the respiratory mask, however that relief may be minimal relief and the minimal relief may be limited to less than 30, 25, 20, 15, 10, 5, 2, or 1 millimeters from the surface of the respiratory mask body. The result is that less attention will be drawn to the user when filter cartridges of a slender or minimal relief are used. The filter medium in the cartridges may cover a wide range of materials that are well known in the art, such as simple pressed fiber filters, including felts, and layered materials including activated carbon or other materials that will sequester harmful inhalants such as particles, dust, vapors, bacteria, mists, aerosols, viruses, and gases. The filter cartridges may be replaced as the cartridges become worn or otherwise ineffective. Cartridges of variable-strength filtration levels may be made to fit the valves thereby allowing a wearer to exchange cartridges depending upon the type and toxicity of inhalants intended to be protected from in a given setting or circumstance. The filtration cartridges may be made in a variety of shapes to complement the valve shape or shape of the area surrounding the valves where a sealing contact between the filter and the respiratory mask must be made.

As depicted in FIG. 3, a series of chin inhalation valves 200 may be incorporated into the chin region of the respiratory mask 100. The chin inhalation valves 200 may include two or more valves of the same style as the inhalation valves 120. When only a single chin inhalation valve 200 is incorporated into the respiratory mask, the chin inhalation valve 200 may be of any shape other than circular or a disc. The size of the chin inhalation valves 200 can vary depending upon the overall size of the respiratory mask, user preferences, aesthetic considerations, and other factors. The chin inhalation valves may be elongated 260 and may include support structures 250 for the valve flaps as are known in the art and depicted in FIG. 4. The elongated chin inhalation valves 260 may also be merged into a single elongated valve that extends in a smile-shape or crescent-shape from the rear edge of the respiratory mask on one side, through the chin region of the respiratory mask, to the rear edge of the respiratory mask on the other side. It is also contemplated that the valves or elongated single valve may not extend fully from the chin to the region of the mask near the wearer's earlobe or rear edge of the respiratory mask, but to a region of the mask in-between the chin and the rear edge. A filter 210, or filter cartridge is then alternatively put into place over each inhalation valve 200, or is put into place over the inhalation valve(s) 200. As shown in FIG. 6, the filter 210 may be a single filter that covers the chin region and extends laterally up the jawline region to a point nearest the earlobe of the user. The filter 210 may be designed to protect the user against harmful inhalants such as biologic agents including viruses, bacteria, and pathogens, chemical agents including gases, mists, vapors, aerosols, and liquids, and foreign objects including particulate matter, dust, smoke, hair, small insects, dander, and pollen.

Both the sealing of the respiratory mask 100 and the comfort of the user may be greatly increased by the incorporation of a rolled edge 150 into the respiratory mask 100. The rolled edge 150 is an inwardly turned, fully incorporated portion of the respiratory mask as shown in FIG. 3. The rolled edge 150 provides a comfortable fit of the respiratory mask on a user's face, while at the same time allowing more material to form a better seal with the face. The rolled edge 150 also provides an adaptable contact area to conform to the different facial sizes and shapes of users of respiratory masks.

As depicted in FIGS. 5 and 6, the respiratory mask 100 may be held in place on the user's face by a head strap 160, a neck strap 170, or both, or the two straps may be combined into one head harness 165 that is worn around the head in a manner that is both comfortable to the user and unobtrusive or otherwise stylish or aesthetically pleasing. The straps or head harness may be made of a comfortable soft, elastomeric material, and may cause the respiratory mask to be snug-fit to the user's face with a hook and loop attachment (i.e. Velcro®), a buckle arrangement, an alligator clip design, or other appropriate method known to those of ordinary skill in the art. The respiratory mask may also be secured to the user's face with prosthetic adhesive materials available from numerous companies, and other adhesive materials known to those of skill in the art. For example, Skin-Bond® from Smith & Nephew, Ben Nye Prosthetic Adhesive, and Kryolan® Medical Adhesive are but a few of the numerous adhesive materials available that are compatible with attachment of a device such as a respiratory mask to the skin of a user.

The invention has been described with reference to various specific and illustrative embodiments. However, it should be understood that many variations and modifications may be made while remaining within the spirit and scope of the invention.

What is claimed is:

1. A respiratory mask comprising:
a. a mask portion having an inner surface and an outer surface for covering a mouth and a nose of a subject's face;
b. at least one one-way exhalation valve mounted on the mask portion;
c. at least one one-way inhalation valve mounted on the mask portion; and
d. a filter associated with the at least one-way inhalation valve and having a minimal relief from the outer surface of the mask portion;
wherein the respiratory mask has a minimal relief from the face of the user.

2. The respiratory mask of claim 1, wherein the user has a first earlobe and a second earlobe, and further wherein the at least one one-way inhalation valve is elongated and extends from a chin region of the mask portion along a jaw-line region of the mask portion toward a region of the mask portion near the user's first earlobe.

3. The respiratory mask of claim 2, wherein the at least one one-way inhalation valve extends from a region of the mask portion near the user's first earlobe, through the chin region of the mask portion, to the mask portion near the user's second earlobe.

4. The respiratory mask of claim 2, wherein the at least one one-way inhalation valve is two or more inhalation valves mounted in a series and extending from the chin region of the mask portion along the jaw-line region of the mask portion toward the region of the mask portion near the user's first earlobe.

5. The respiratory mask of claim 4, wherein the at least one one-way inhalation valve is two or more inhalation valves mounted in a series and extending from a region of the mask portion near the user's first earlobe, through the chin region of the mask portion, to the mask portion near the user's second earlobe.

6. The respiratory mask of claim 1, wherein the at least one one-way inhalation valve is two or more inhalation valves mounted on a chin region of the mask portion.

7. The respiratory mask of claim 1, wherein the at least one one-way inhalation valve is of a shape other than circular and is mounted in a chin region of the mask portion.

8. The respiratory mask of claim 1, wherein the mask portion is made of a substantially transparent material.

9. The respiratory mask of claim 1, wherein the mask portion is made of a substantially colorless material.

10. The respiratory mask of claim 1, wherein the mask portion has multiple colors.

11. The respiratory mask of claim 1, wherein the at least one one-way exhalation valve and the at least one one-way inhalation valve are made of a substantially transparent material.

12. The respiratory mask of claim 1, wherein the at least one one-way exhalation valve and the at least one one-way inhalation valve are made of a substantially colorless material.

13. The respiratory mask of claim 1, wherein the minimal relief of the filter from the surrounding outer surface of the mask portion is less than about 30 millimeters.

14. The respiratory mask of claim 1, wherein the minimal relief of the filter from the surrounding outer surface of the mask portion is flush with the outer surface of the mask portion.

15. The respiratory mask of claim 1, wherein the filters are removable filter cartridges.

16. The respiratory mask of claim 15, wherein the removable filter cartridges comprise a filter body and a filter medium and further wherein the filter body connects to the mask portion by threads.

17. The respiratory mask of claim 15, wherein the removable filter cartridges comprise a filter body and a filter medium and further wherein the filter body snaps into the mask portion.

18. The respiratory mask of claim 1, further comprising a rolled edge on the mask portion.

19. The respiratory mask of claim 1, wherein the mask portion is secured to the face of the user by a neck strap.

20. The respiratory mask of claim 1, wherein the mask portion is secured to the face of the user by a head strap.

21. The respiratory mask of claim 1, wherein the mask portion is secured to the face of the user by a neck strap and a head strap.

22. The respiratory mask of claim 1, wherein the mask portion is secured to the face of the user by a head harness.

23. The respiratory mask of claim 1, wherein the mask portion is secured to the face of the user by an adhesive material.

24. The respiratory mask of claim 1, wherein the minimal relief of the mask portion from the face of the user is less than about 30 millimeters.
